(19) United States
(12) Patent Application Publication
(10) Pub. No.: US 2025/0190596 A1
(43) Pub. Date: Jun. 12, 2025

(54) TECHNIQUES FOR ENFORCING ACCESS CONTROL POLICIES FOR APPLICATION-SPECIFIC INTEGRATED CIRCUITS (ASICS)

(71) Applicant: Cisco Technology, Inc., San Jose, CA (US)

(72) Inventors: SAMIR VALJIBHAI RAJGOR, Santa Clara, CA (US); SACHIN AGARWAL, Fremont, CA (US); AVIRAN KADOSH, Moreshet, IL (US); CHIRAG SHROFF, Cary, NC (US)

(73) Assignee: Cisco Technology, Inc., San Jose, CA (US)

(21) Appl. No.: 18/535,894

(22) Filed: Dec. 11, 2023

(51) Int. Cl. G06F 21/62

(52) U.S. Cl. CPC G06F 21/62

(57) ABSTRACT

This disclosure describes techniques for an isolated Root of Trust (RoT) component of a System on Chip (SoC), such as an SoC associated with a networking-related application, to: (i) enforce access to one or more protected addresses associated with the SoC using a secure communication channel, (ii) limit access to one or more restricted addresses to authorized external devices, and/or (iii) detect an operational environment within which the SoC operates based on access rates associated with special addresses associated with the SoC and modify operation of the SoC based on the detected operational environment. The RoT component may be implemented as a dedicated security subsystem with an isolated processor and memory regions that are inaccessible to the rest of the SoC.

### TECHNICAL FIELD

The present disclosure relates generally to chip-based security. Specifically, the present disclosure relates to systems and methods for using a root-of-trust for enforcing access control policies for an application-specific integrated circuit (ASIC).

### BACKGROUND

An application-specific integrated circuit (ASIC) generally refers to an integrated circuit designed for a specific purpose. An ASIC may be efficient at performing the specific purpose for which it was designed compared to general-purpose circuits, like General Processing Units (GPUs) or Central Processing Units (CPUs), which can perform many different functions, but often less efficiently. A product may include a number of ASICs. As one example, a product could be a switch or a router that includes different ASICs to support different protocols. Other ASICs could be included for other purposes.

Various types of security risks threaten the integrity of the operation of an ASIC. In some cases, to prevent attacks, a private key is placed in a nonvolatile electrically erasable programmable read-only memory (EEPROM) (or battery-backed static random-access memory (SRAM)) and uses hardware cryptographic operations such as digital signatures or encryption. The nonvolatile memory is often vulnerable to invasive attack mechanisms. The protection against such attacks may require the use of active tamper detection/prevention circuitry which must be continually powered.

Different types of device tampering may occur and include attempts to unauthorizedly modify a device's capability from a lower-end product to a higher-end product, and or gain the unlawful possession of a device from a manufacturer to circumvent sales channels to sell or resell it to the customer at a lower price. Maintaining the authenticity of a device is vital for customer assurance and to ensure the reliability of the device itself. For example, a device may be used to support critical network functions such as in power grid applications requiring an expected guaranteed level of performance. The unauthenticated device can be susceptible to security intrusions that can degrade the device's performance and may result in network outages.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides a system architecture diagram of an example device 100 with a system-on-chip (SoC) that includes a Root of Trust (RoT) central processing unit (CPU) complex.

FIG. 2 provides an operational example of the operation of an RoT CPU complex that is configured to establish a secure communication channel with an external device, such as a host processor.

FIG. 3 provides an operational example of firmware that may be accessed by an ROT CPU complex.

FIG. 4 is a flowchart diagram of an example process for managing access to an SoC address based on whether the address is protected.

FIG. 5 is a flowchart diagram of an example process for managing access to an SoC address based on whether the address is restricted.

FIG. 6 is a flowchart diagram of an example process for setting an operational configuration of an SoC based on access rates associated with specially-designated addresses associated with the SoC.

FIG. 7 shows an example computer architecture for a computer capable of executing program components for implementing the functionality described above.

### DESCRIPTION OF EXAMPLE EMBODIMENTS

### Overview

This disclosure describes techniques for an isolated Root of Trust (ROT) component of a System on Chip (SoC), such as an SoC associated with a networking-related application, to: (i) enforce access to one or more protected addresses associated with the SoC using a secure communication channel, (ii) limit access to one or more restricted addresses to authorized external devices, and/or (iii) detect an operational environment within which the SoC operates based on access rates associated with special addresses associated with the SoC and modify operation of the SoC based on the detected operational environment.

A method to perform the techniques described herein may include intercepting, by an isolated Root of Trust (RoT) code and from an interconnect component associated with the SoC, a first access request by a first device, wherein the first access request is associated with a first memory address of the SoC. The method may further include determining, by the isolated ROT code, that the first memory address is protected; based on determining that the first memory address is protected, establishing, by the isolated ROT code, a secure communication channel between the first device and the isolated ROT code. The method may further include providing, by the isolated ROT code and using the secure communication channel, first data determined based on contents of the first memory address to the first device.

Another method to perform the techniques described herein may include determining, by an isolated Root of Trust (RoT) code, that an access rate associated with a first memory address associated with the SoC falls below a threshold, wherein the first memory address is associated with an expected operational environment of the SoC. The method may further include, based on determining that the access rate falls below the threshold, determining that the SoC is operating outside the expected operational environment. The method may further include, based on determining that the SoC is operating outside the expected operational environment, modifying, by the isolated ROT code, operation of the SoC, wherein modifying the operation of the SoC comprises at least one of: disabling operation of the SoC, disabling a first functionality associated with the SoC, or enabling a first functionality associated with the SoC.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for an isolated Root of Trust (RoT) component of a System on Chip (SoC), such as an SoC associated with a networking-related application, to: (i) enforce access to one or more protected addresses associated with the SoC using a secure communication channel, (ii) limit access to one or more restricted addresses to authorized external devices, and/or (iii) detect an operational environment within which the SoC operates based on access rates associated with special addresses associated with the SoC and modify operation of the SoC based on the detected operational environment. The RoT component may be implemented as a dedicated security subsystem with an isolated processor and memory regions that are inaccessible to the rest of the SoC.

The RoT component may then be configured to enforce one or more access controls for accessing one or more memory addresses associated with the corresponding SoC and/or with the corresponding SoC configuration engine. For example, the RoT component may designate at least a segment of addresses as protected. When an address is designated as being protected, the RoT component only allows access to that address using a secure communication channel between the RoT component and the requesting external device. Accordingly, in some cases, when a requested address is designated as being protected, the RoT component provides one or more keys (e.g., a public key and/or a private key) to the requesting device that will enable the requesting device to transmit future requests and/or receive requested data using a secure communication channel associated with the transmitted keys. In some cases, the RoT component establishes and/or verifies association of received data with the established channel using a cryptographic accelerator hardware.

In some cases, the RoT component enforces selective access to addresses designated as being restricted. A restricted address may be an address that is accessible by components of the SoC and/or that is accessible by a selected set of external devices. In some cases, after receiving a request for accessing a restricted memory address, the RoT component determines whether the requesting device is authorized to access the address and, if not, denies the requested access (e.g., by aborting the processing of the access request). To do so, the RoT component may query a predefined access control list, which lists authorized devices and their corresponding access privileges. The predefined access control list may be stored, for example, as part of the firmware associated with the RoT component. Additionally, the RoT component may use dynamic security policies that consider contextual factors such as the current operating state of the SoC, the security posture of the requesting device, and recent access patterns to make access decisions.

In some cases, the RoT component is configured to detect an operational environment within which the corresponding SoC operates based on access requests received by the SoC and/or intercepted by the RoT component. For example, in some cases, different operational environments may be associated with different patterns of accessing different addresses. Some addresses may only be known to external devices associated with particular operational environments. Accordingly, in some cases: (i) frequent access to such exclusively known addresses may indicate operation of the SoC within the particular operational environments, and/or (ii) infrequent and/or lack of access to such exclusively known addresses may indicate operation of the SoC outside the particular operational environments. Accordingly, in some cases, the RoT component may use access patterns associated with addresses in the SoC and/or in the SoC configuration engine to determine an operational environment within which the SoC operates. In some cases, the RoT component may be configured to disable some and/or all of the functionalities of the SoC based on the operational environment within which the SoC is detected to operate.

In some cases, the RoT component may be configured to disable operation of the SoC, enable one or more functionalities of the SoC, and/or disable one or more functionalities of the SoC based on the operational environment within which the SoC is detected to operate. For example, in some cases, if the SoC is reserved for operation within a set of authorized environments, the RoT component may disable the operation of the SoC if the RoT component detects that the SoC is operating outside the authorized set of environments. As another example, in some cases, if a set of functionalities of the SoC are reserved for a set of authorized environments, the RoT component may disable the set of functionalities if the RoT component detects that the SoC is operating outside the authorized set of environments. As another example, in some cases, if a set of functionalities of the SoC are reserved for a set of authorized environments, the RoT component may ensure that the set of functionalities are enabled if the RoT component detects that the SoC is operating inside the authorized set of environments.

In some cases, the isolated ROT component enables enhanced security associated with the SoC in various ways. For example, by implementing the ROT as a dedicated security subsystem with its own isolated processor and memory, the techniques described herein enable a hardware-enforced foundation of trust. As another example, by requiring a secure communication channel for accessing protected addresses, the RoT component ensures cryptographic verification of access requests. As another example, by tracking access requests to addresses associated with particular environments, the ROT may infer the current environment and modify SoC operation accordingly. This allows context-aware security policies tailored to different environments and use cases. In some cases, automatically disabling functions when an unauthorized environment is detected provides proactive protection.

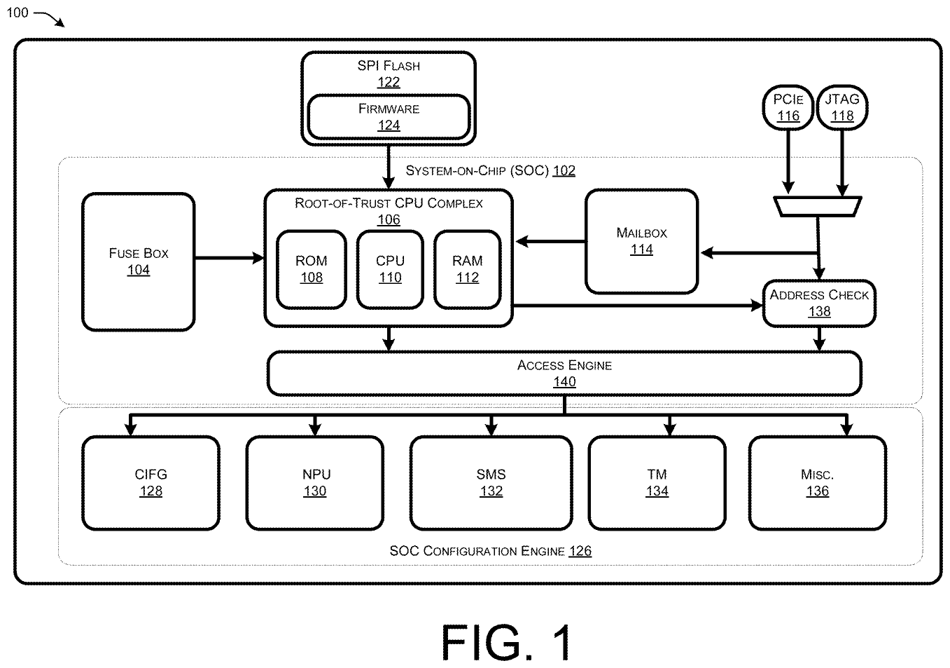

FIG. 1 provides a system architecture diagram of an example device 100 with a system-on-chip (SoC) 102 that includes a Root of Trust (RoT) central processing unit (CPU) complex 106. The RoT CPU complex 106 may be configured to operate in a zero-trust environment of the device 100. The RoT CPU complex 106 may be an isolated unit that is configured to establish a hardware-based root of trust (HWROT) for the device 100. The HWROT may provide a secured foundation for the device 100 by ensuring the integrity of critical firmware, applications, and/or data associated with the device 100. The RoT CPU complex 106 may provide cryptographic services and/or protected execution environments to support trusted boot, secured storage, and/or other security-critical functions needed in a zero-trust architecture. By leveraging hardware-enforced isolation and attestation capabilities, the ROT CPU complex 106 may enable the device 100 to operate securely even in the presence of compromise elsewhere in the system.

As depicted in FIG. 1, the SoC 102 includes a fuse box 104, an RoT CPU complex 106, a mailbox 114, a Peripheral Component Interconnect Express (PCI-e) interface 116, a Joint Test Action Group (JTAG) interface 118, an access engine 140, and an address check component 138. In some cases, ROT CPU complex 106 is an isolated environment within the SoC 102 that operates in a zero-trust mode. The RoT CPU complex 106 may boot from immutable code stored in the secured Read-Only Memory (ROM) 108 and execute, using the secured Random Access Memory (112), secured firmware 124 stored on the serial peripheral interface (SPI) flash memory 122. The RoT CPU complex 106 may use cryptographic keys to authenticate external data like firmware and licensing codes before enabling SoC features.

As depicted in FIG. 1, the ROT CPU complex 106 includes a secured CPU (e.g., an ARC® processor) 110 that boots from code stored on the secured ROM 108 and executes secured firmware 124 retrieved from the SPI flash memory 122. In some embodiments, the secured firmware 124 is encrypted and stored on the SPI flash memory 122. In some embodiments, the SPI flash memory 122 may be used to store a firmware that is explicitly accessible by sending commands from instructions configured in the RoT code stored on the secured ROM 108. The ROT code may be input during the device manufacturing process and may include information from a digital identity certificate associated with the device 100 that enables the device 100. For example, the ROT code may include device enablement information that has been previously programmed into a hardware component during the manufacture of the device 100. In some cases, the SPI flash memory 122 stores firmware images and licensing codes used by the ROT CPU complex 106. At least some of the data stored by the SPI flash memory 122 may be encrypted and authenticated by the RoT CPU complex 106 before being executed or used to configure SoC features. In some cases, configuration data is passed to the device 100 via one or more digital identity certificates encoding one or more SKUs. In some cases, the firmware validates a certificate during each power-up and then extracts the encoded SKU to ascertain what configurations of the device 100.

In some cases, the secured CPU 110 includes specific cryptographic and computational hardware to facilitate the processing of cryptographic information associated with operation of the device 100. In some cases, the RoT CPU complex 106 configures the features of the device 100 (e.g., which may be a programmable device) with the ROT code stored in the secured ROM 108. In some cases, the secured CPU 110 executes instructions associated with the RoT code to access one or more built-in keys from secured storage of a fuse box 104 to create multiple type configurations for the device 100. Each type configuration may be identified by a different stock-keeping unit (SKU) that is decrypted by the built-in keys.

In some cases, the RoT code is configured to never be turned off as it operates in a zero-trust environment. For example, in some cases, the RoT CPU complex 106 operates independently of a host processor and/or an application processor to provide hardware-based security services. By isolating critical security functions in tamper-resistant hardware, the RoT CPU complex 106 may serve as a root of trust that protects the confidentiality, integrity, and/or authenticity of sensitive data and/or software associated with the device 100. In some cases, the host processor and/or the application processor may rely on the RoT CPU complex 106 to securely boot the system, store credentials and keys, and/or provide other cryptographic operations. For example, the RoT CPU complex 106 may use dedicated silicon fuses or memory to store device secrets and private keys that may be used for cryptographic functions like digital signatures. In some cases, ROT CPU complex 106 enables advanced security features like hardware-backed attestation. For example, in some cases, the RoT CPU complex 106 may be configured to generate signed measurements describing the hardware and/or software state associated with the RoT CPU complex 106.

In some cases, the device 100 is programmed to contain one or more electronic fuses (eFuses), such as one or more secured keys (e.g., built-in keys), contained in the fuse box 104 during manufacturing. The fuse box 104 may store cryptographic keys and device security settings in eFuses programmed during manufacturing. The eFuses may enable the RoT firmware to authenticate external data and licenses. The fuse box settings may also permanently enable or disable certain SoC features and functions.

The device 100 may configure the control of the Media Access Control Security (Mac Sec) for authentication and encryption of traffic over Ethernet on Layer 2 local area network (LAN) networks (e.g., using the SoC configuration engine 126). The manufacturing process associated with the device 100 may be configured to ensure that a secured boot mechanism starts the RoT by setting up one or more keys (e.g., a private-public key pair in the case of asymmetric encryption or a private key in the case of symmetric encryption) into the device 100 during the manufacturing process. In some embodiments, a CPU associated with the device 100 (e.g., the secured CPU 110) generates different authentication keys by generating random numbers using a true random number generator (TRNG) and storing the random numbers in the fuse box 104 with the assistance of firmware. In some embodiments, other than the built-in keys, the eFuses may be configured to store device security related to control and status bits.

In some cases, the mailbox 114 provides an interface for the ROT CPU complex 106 to securely communicate with other components. The mailbox 114 may enable the RoT CPU complex 106 to receive encrypted data like firmware and licensing codes from sources like the PCIe interface 116 and/or from the SPI flash memory 122. In some cases, the mailbox 114 contains instructions (e.g., encrypted instructions) associated with communication protocols and/or handshaking logic to allow the mailbox 114 to securely interface with the RoT CPU complex 106 and/or other components (e.g., the PCIe interface 116 and/or the JTAG interface 118). The mailbox 114 may also contain security control logic such as access control lists to ensure only authorized components may communicate via the mailbox 114 interface.

The PCIe interface 116 may enable an external device (e.g., an external host processor) to communicate with the SoC 102. For example, the PCIe interface 116 may receive, from the external device, requests for accessing (e.g., retrieving data from and/or modifying data stored in) one or more addresses (e.g., one or more registers) associated with the SoC configuration engine 126. Examples of such access requests include, in the context of a networking-related SoC, requests to read or write to registers controlling port enablement to turn on/off specific network ports, requests to access registers controlling MAC address filters for setting allowed MAC addresses, and requests to set registers controlling Quality of Service (QoS) parameters like bandwidth limits or queue priorities for different traffic flows. The PCIe interface 116 may enable external control over networking features by exposing key configuration registers to attached devices over the industry standard PCIe bus.

The JTAG interface 118 may enable an external device (e.g., an external host processor) to communicate with the SoC 102 to access and/or control on-chip debug modules and/or embedded instruments (e.g., trace buffers). For example, the JTAG interface 118 associated with a networking-related SoC may provide external visibility into internal packet processor state for debugging firmware, allow tracing packet flow through the SoC 102 to monitor performance, provide the ability to externally control to simulate anomalous scenarios by injecting anomalous packets, and/or the like. In some cases, the JTAG interface 118 grants external tools debug access to SoC 102 internals through a common 4 or 5 wire test access port without requiring vendor-specific connections.

The SoC configuration engine 126 stores configuration data (e.g., configuration registers) associated with the SoC 102. The SoC configuration engine 126 may include various configurable and status registers for different functional blocks, such as the Configuration Interface (CIFG) 128, the Network Processing Unit (NPU) 130, the Shared Memory System (SMS) 132, the Traffic Management (TM) component 134, and a component 136 that controls access to other types of configuration data such as registers for frequency monitoring, mapping of physical ports (e.g., physical pins) associated with the SoC 102 to functionalities (e.g., functional blocks) associated with the SoC 102, Inter-Integrated Circuit (I2C) bus configuration, and/or enabling or disabling JTAG functionality.

The access engine 140 controls access to internal SoC data and/or functionality, such as to the SoC configuration engine 126. In some cases, the access engine 140 validates any access requests using cryptographic signatures or identifiers to prevent unauthorized requests from modifying SoC configuration or operation. Once an access request is authenticated, the access engine 140 may determine if the requested access is allowed based on permissions, licenses, and any ROT constraints. The access engine 140 will deny the request if the external entity does not have proper rights.

In some cases, components of the SoC configuration engine 126 provide configurable settings and operational statuses for specific features the SoC 102. For example, the CIFG 128 may store data controlling serialization/deserialization settings, port configurations, and/or bandwidth management. As another example, the NPU 130 may store data controlling MAC layer processing management and/or Access Control Lists (ACL) scaling. As another example, the SMS 132 may store data controlling buffer scaling within the device 100. As another example, the TM component 134 may store data controlling timing meters, counters, and queue scaling for traffic management.

As depicted in FIG. 1, the ROT CPU complex 106 may be configured to intercept all access requests received from external devices (e.g., a host processor) through one or more access interfaces (e.g., through the PCIe interface 116). For example, the mailbox 114 may be configured to provide all access requests to the ROT CPU complex 106. As another example, the mailbox 114 may be configured to generate an interrupt (e.g., a hardware interrupt) signal when the mailbox 114 receives an access request from an external device through an access interface. As another example, the RoT CPU complex 106 may be configured to execute operations that are configured to monitor access requests received by the mailbox 114. In some cases, configuration data associated with the SoC (e.g., with the mailbox) defines a set of memory addresses in the memory address space associated with the ROT CPU complex 106. The configuration data may be firmware generated prior to finalization of the SoC's manufacturing.

The mailbox 114 may be an interconnect component that provides a secure interface for the RoT CPU complex 106 to communicate with one or more external devices. For example, the mailbox 114 may be configured to provide all access requests to the RoT CPU complex 106. The mailbox 114 may provide all access requests to the RoT CPU complex 106 for validation before allowing access to internal SoC data or functionality. For example, the ROT CPU complex 106 may authenticate access requests using cryptographic signatures or identifiers to prevent unauthorized requests from modifying SoC configuration or operation. After authenticating a request, the RoT CPU complex 106 may check whether the requested access is permitted based on permissions, licenses, and/or any root of trust constraints before allowing the request to proceed. By centralizing all external access through the mailbox 114 and ROT CPU complex 106, the SoC 102 may operate securely even when compromised components exist elsewhere in the system.

As depicted in FIG. 1, the SoC 102 may have an address check component 138 that is configured to receive all access requests from one or more access interfaces and block access requests to access-controlled (e.g., restricted and/or protected) addresses. In some cases, the access requests will be provided both the address check component 138 and to the ROT CPU complex 106. In some cases, because the address check component 138 blocks access requests to access-controlled (e.g., restricted and/or protected) addresses, access to such addresses is provided through and/or controlled through the RoT CPU complex 106. In some cases, the address check component 138 is configured to only authorize access to access-controlled addresses to the RoT CPU complex 106 and/or to one or more other authorized components that are internal to the SoC 102.

The RoT CPU complex 106 may then be configured to enforce one or more access controls for accessing one or more memory addresses associated with the SoC 102 and/or with the SoC configuration engine 126. For example, the ROT CPU complex 106 may designate at least a segment of addresses as protected. When an address is designated as being protected, the RoT CPU complex 106 only allows access to that address using a secure communication channel between the ROT CPU complex 106 and the requesting external device. Accordingly, in some cases, when a requested address is designated as being protected, the RoT CPU complex 106 provides one or more keys (e.g., a public key and/or a private key) to the requesting device that will enable the requesting device to transmit future requests and/or receive requested data using a secure communication channel associated with the transmitted keys. In some cases, the RoT CPU complex 106 establishes and/or verifies association of received data with the established channel using a cryptographic accelerator hardware.

For example, in some cases, in response to receiving a request for accessing an address associated with the SoC 102 and/or the SoC configuration engine 126, the ROT CPU complex 106 performs the following operations: (i) determines whether the requested address is protected, and (ii) if the requested address is protected: (a) establishes a secure communication channel with the requesting device by generating (e.g., using the cryptographic accelerator hardware) one or more keys associated with the channel, (ii) provides the keys associated with the secure communication channel to the requesting device, and (iii) after establishment of the secure communication channel, authenticates each request received from the requesting device and, if the request is authenticated, accesses the requested address, provides the requested data, and/or makes the requested data modifications. In some cases, to authenticates requests associated with a secure communication channel, the ROT CPU complex 106 uses the cryptographic accelerator hardware.

In some cases, to establish a secure communication channel with an external device that has requested access to a protected address, the RoT CPU complex 106 generates an asymmetric key pair, provides the public key to the external device, and retains the private key. The RoT CPU complex 106 may then use the private key to authenticate requests received via the secure channel and encrypt responses to the external device. The external device may use the public key to encrypt its requests to the protected address. This allows secure communication between the RoT CPU complex 106 and external devices needing access to protected memory regions. This asymmetric cryptographic approach allows the ROT CPU complex 106 to selectively grant external devices access to protected memory regions in a secure manner. However, the RoT CPU complex 106 may utilize other encryption techniques as well. For example, the RoT CPU complex 106 mat establish shared symmetric keys with external devices through a key exchange protocol. The symmetric keys may then encrypt the communication channel.

Additionally, the RoT CPU complex 106 may employ various access control policies to determine which external devices may access protected memory and what type of access they are granted. For example, read-only access may be allowed for some devices, while other devices may be granted read/write access depending on their credentials. The ROT CPU complex 106 may consult an access control list to determine which devices have which privileges. Furthermore, the RoT CPU complex 106 may establish time-limited secure channels with automatic expiration. This may be achieved by putting expiry time stamps in the encrypted requests and responses. The RoT CPU complex 106 may then reject any expired communications on a secure channel after the designated time window has passed. This approach may be configured to limit the duration that an external device has access to protected memory, reducing potential security risks from compromised devices. In some cases, the RoT CPU complex 106 may use one or more intrusion detection capabilities to identify and block suspicious activity over established secure channels. By analyzing factors like request frequency, anomalies in access patterns, and potentially malformed packet data, the ROT CPU complex 106 may detect potential intrusion attempts and terminate secure channels when a threat is perceived.

In some cases, the RoT CPU complex 106 uses one or more cryptographic algorithms to implement a secure communication channel with an external device. Examples of such algorithms Advanced Encryption Standard (AES), Rivest-Shamir-Adleman (RSA), Elliptic Curve Cryptography (ECC), Secure Hash Algorithm (SHA)-256 (SHA-256), Hash-based Message Authentication Code (HMAC), and Diffie-Hellman. In some cases, the RoT CPU complex 106 uses one or more cryptographic accelerator hardware to implement a secure communication channel with an external device. A cryptographic accelerator hardware may use at least one of an ASIC or a device with an Advanced Encryption Standard instruction set (AES-NI) capability. For example, dedicated ASICs or AES-NI instructions may accelerate AES or SHA operations. In some cases, external trusted cryptographic processors may also complement the on-chip capabilities. In some cases, to facilitate secure code execution and authentication, the RoT CPU complex 106 may use a trusted zone environment to prevent compromised software from accessing protected memory regions or security parameters. In some cases, to verify the integrity of executed software, the ROT CPU complex 106 may use signed code attestation.

Accordingly, in some cases, to prevent man-in-the-middle attacks, the ROT CPU complex 106 implements secure communication channels when providing access to protected memory regions. The RoT CPU complex 106 may utilize asymmetric cryptography to authenticate external devices and encrypt the communication channels. For example, the ROT CPU complex 106 may generate a public-private key pair, provide the public key to an external device requesting access, and retain the private key. The external device uses the public key to encrypt requests, while the RoT CPU complex 106 uses the private key to decrypt requests, authenticate the source, and encrypt any responses. This ensures two-way authentication and prevents a malicious actor from intercepting or manipulating the communications. In some cases, the cryptographic algorithms and hardware accelerators leveraged by the RoT CPU complex 106 also make it very difficult for a man-in-the-middle attacker to decrypt or manipulate the contents of a secure channel without being detected. In some cases, the computational complexity of cryptographic operations like AES and SHA-256 renders real-time brute force attacks infeasible.

In some cases, the RoT CPU complex 106 enforces selective access to addresses designated as being restricted. A restricted address may be an address that is accessible by components of the SoC 102 and/or that is accessible by a selected set of external devices. In some cases, after receiving a request for accessing a restricted memory address, the ROT CPU complex 106 determines whether the requesting device is authorized to access the address and, if not, denies the requested access. To do so, the RoT CPU complex 106 may query a predefined access control list, which lists authorized devices and their corresponding access privileges. The predefined access control list may be stored, for example, as part of the firmware 124 stored on the SPI flash memory 122. Additionally, the ROT CPU complex 106 may use dynamic security policies that consider contextual factors such as the current operating state of the SoC 102, the security posture of the requesting device, and recent access patterns to make access decisions. The dynamic security policies may also be stored, for example, as part of the firmware 124 stored on the SPI flash memory 122.

In some cases, the RoT CPU complex 106 employs advanced monitoring and logging mechanisms to track access to restricted addresses. These mechanisms may include recording the identity of the requesting device, the nature of the request, and the time and duration of access. This data may be crucial for forensic analysis in the event of a security breach. The RoT CPU complex 106 may also implement real-time monitoring to detect and respond to abnormal access patterns or unauthorized attempts to access restricted addresses, thereby providing a proactive security layer. Furthermore, the RoT CPU complex 106 may be configured to dynamically adjust its security parameters based on the current threat landscape. For example, in response to increased security threats, the RoT CPU complex 106 may tighten access controls, require more stringent authentication, or temporarily restrict access to certain memory addresses. As another example, during periods of lower risk, the ROT CPU complex 106 may relax certain controls to optimize system performance while still maintaining an adequate level of security.

In some cases, the RoT CPU complex 106 is configured to detect an operational environment within which the SoC 102 operates based on access requests received by the SoC 102 and/or intercepted by the RoT CPU complex 106. For example, in some cases, different operational environments may be associated with different patterns of accessing different addresses. Some addresses may only be known to external devices associated with particular operational environments. Accordingly, in some cases: (i) frequent access to such exclusively known addresses may indicate operation of the SoC 102 within the particular operational environments, and/or (ii) infrequent and/or lack of access to such exclusively known addresses may indicate operation of the SoC 102 outside the particular operational environments. Accordingly, in some cases, the RoT CPU complex 106 may use access patterns associated with addresses in the SoC 102 and/or in the SoC configuration engine 126 to determine an operational environment within which the SoC 102 operates. In some cases, the ROT CPU complex 106 may be configured to disable some and/or all of the functionalities of the SoC 102 based on the operational environment within which the SoC 102 is detected to operate.

In some cases, the RoT CPU complex 106 may be configured to cause determining access rates for one or more addresses and using the access rates to determine an operational environment within which the SoC 102 operates. For example, the ROT CPU complex 106 may determine (e.g., based on data stored as part of the firmware 124 stored on the SPI flash memory 122) that devices associated with a particular companies execute code associated with software development kits (SDKs) that frequently access a set of reserved configuration registers associated with the SoC configuration engine 126. Based on this determination, the RoT CPU complex 106 may determine: (i) that the SoC 102 is operating outside the operational environment associated with the company if the access rates for the set of reserved configuration registers falls below a threshold (e.g., if the set of reserved configuration registers are not accessed within a defined past period), and/or (ii) that the SoC 102 is operating inside the operational environment associated with the company if the access rates for the set of reserved configuration registers exceed or equal a threshold (e.g., if the set of reserved configuration registers are accessed within a defined past period). In some cases, an access rate is determined based on a number of requests to access a set of memory addresses accessed by a software application that is deployed within an expected operational environment.

In some cases, the firmware 124 stored on the SPI flash memory 122 includes policies defining how access rates relate to operational environments. For example, the firmware 124 may include predefined thresholds for access frequencies to sets of addresses that are indicative of certain operational environments. The policies may specify that if access requests to a given set of addresses exceed a certain threshold over a defined time period, then the SoC 102 is likely operating in a particular environment associated with frequent access to those addresses. In some cases, if access requests fall below a threshold, the SoC 102 is determined to be operating outside of that environment.

The policies stored on the firmware 124 may also define different access rate thresholds for read requests versus write requests to designated memory addresses. For example, a high volume of writes to certain configuration registers may indicate a development environment, while mainly read access may indicate a production environment. In some cases, the firmware 124 can specify more complex behavioral profiles involving patterns of address access rates that map to different contexts. The policies stored on the firmware 124 may also indicate how to interpret relative changes in access patterns over time. For example, a sharp decline in writes to a certain register range may mean that a testing phase has ended, and the SoC 102 is transitioning from development to production. The RoT CPU complex 106 may be configured to continuously monitor address access rates and correlate them to the firmware policies in order to make accurate inferences regarding the current operational environment. This allows the ROT CPU complex 106 to detect if the SoC 102 is operating outside of an intended context and perform appropriate actions to maintain security and/or to enforce expected functionality offerings.

As described above, the RoT CPU complex 106 may be configured to disable operation of the SoC 102, enable one or more functionalities of the SoC 102, and/or disable one or more functionalities of the SoC 102 based on the operational environment within which the SoC 102 is detected to operate. For example, in some cases, if the SoC 102 is reserved for operation within a set of authorized environments, the ROT CPU complex 106 may disable the operation of the SoC 102 if the RoT CPU complex 106 detects that the SoC is operating outside the authorized set of environments. As another example, in some cases, if a set of functionalities of the SoC 102 are reserved for a set of authorized environments, the RoT CPU complex 106 may disable the set of functionalities if the RoT CPU complex 106 detects that the SoC is operating outside the authorized set of environments. As another example, in some cases, if a set of functionalities of the SoC 102 are reserved for a set of authorized environments, the RoT CPU complex 106 may ensure that the set of functionalities are enabled if the ROT CPU complex 106 detects that the SoC is operating inside the authorized set of environments.

In some cases, to disable the operation of the SoC 102, enable a functionality associated with the SoC 102, and/or disable a functionality associated with the SoC 102, the ROT CPU complex 106 may modify the configuration data (e.g., the configuration registers) stored on the SoC configuration engine 126. For example, the RoT CPU complex 106 may modify (e.g., using an eFuse) configuration registers that control the clock gates for different components of the SoC 102. By gating the clocks to selective portions of the SoC 102, the RoT CPU complex 106 may effectively disable those components. The RoT CPU complex 106 may also modify configuration registers for power domains to cut power to certain modules and disable them. In some cases, to enable or disable specific functionalities of the SoC 102, the RoT CPU complex 106 may update configuration registers that act as feature switches. For example, setting a register controlling cryptographic accelerators to zero may disable those accelerators, while setting such a register to one enables them. As another example, ROT CPU complex 106 may toggle access and permissions bits in memory protection unit registers to open or restrict access to certain memory regions and thus enable or disable associated functionality. As another example, register fields controlling reset generation, external device interfaces, debug modes, and other key logic blocks may provide mechanisms for the ROT CPU complex 106 to holistically disable SoC 102 operation or selectively enable/disable specific features by updating the SoC configuration engine 126.

In some embodiments, the RoT CPU complex 106 may include functions embedded such as a watchdog monitor or timer, to monitor operational characteristics of components enabled in the SoC 102 in relation to the detected operational environment. In some embodiments, an eFuse may be triggered by the ROT CPU complex 106 for the one-time disablement of functions. The RoT CPU complex 106 may control the processor throughput, for example, configure higher processing rates dependent on the jurisdiction of use, to abide by respect export regulations. In some cases, using the ROT CPU complex 106 to enable enforcement of an isolated trusted code, is not susceptible to hacking or license subversion.

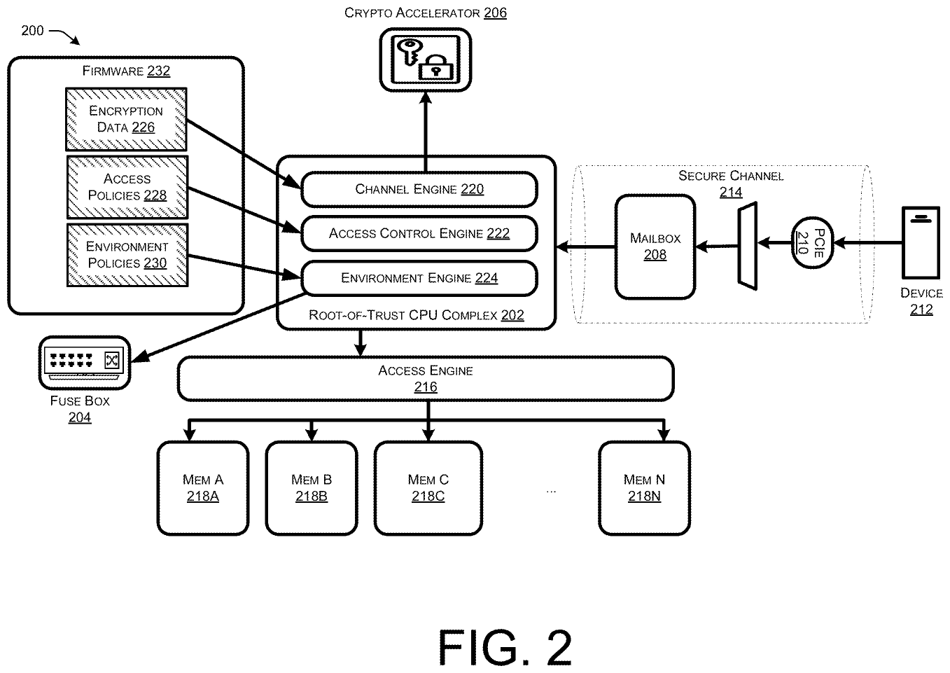

FIG. 2 provides an operational example 200 of the operation of an RoT CPU complex 202 that is configured to establish a secure communication channel 214 with an external device 212, such as a host processor. As depicted in FIG. 2, the ROT CPU complex 202 includes a channel engine 220, an access control engine 222, and an environment engine 224. The channel engine 220 may be configured to: (i) establish the secure communication channel 214 between the external device 212 and the RoT CPU complex 202 (e.g., via the PCI-e interface 210 and the mailbox 208), (ii) store the encryption data (e.g., the cryptographic keys, such as public and/or private keys) associated with the secure communication channel 214 as part of encryption data 226 stored on the firmware 232 (e.g., on an SPI flash memory accessible by the RoT CPU complex 202), and (iii) using the encryption data 226 to encrypt data transmitted using the secure communication channel 214 and/or to authenticate data received using the secure communication channel 214.

To perform cryptographic authentication operations, the channel engine 220 may use a cryptographic accelerator hardware 206 that resides within or outside the ROT CPU complex 202. The cryptographic accelerator hardware 206 may use at least one of an ASIC or a device with an Advanced Encryption Standard instruction set (AES-NI) capability. For example, dedicated ASICs or AES-NI instructions may accelerate AES or SHA operations. In some cases, the channel engine 220 executes operations within a trusted zone environment.

As further depicted in FIG. 2, the ROT CPU complex 202 includes an access control engine 222 that is configured to receive a request received through the secure communication channel 214 (e.g., a request authenticated by the channel engine 220) and to process the request based on whether the request seeks to access a protected address and/or a restricted address. In some cases, if the access control engine 222 determines that a request seeks access to a protected address, the RoT CPU complex 202 ensures that the request is received through the secure communication channel 214, performs operations associated with the request (e.g., by interacting with the memory addresses 218A-218N, such as with memory address A 218A, with memory address B 218B, with memory address C 218C, or with memory address N 218N, via the access engine 216), and/or provides any data responsive to the request via the secure communication channel 214.

The access control engine 222 may be configured to determine an access request based on access control policies 228 stored as part of the firmware 232. The access control policies 228 may include lists of protected and/or restricted addresses. The access control engine 222 may consult an access control list to determine which devices have which privileges and/or which addresses can only be accessed via a secure communication channel. For example, the access control list may specify certain external devices that have read-only access to particular memory addresses, while other devices may have full read/write privileges. The access control list may also indicate which memory regions require authenticated secure channel access versus those that permit open access. The access control policies 228 may further define dynamic security parameters based on factors like the current operating mode, security posture, and recent access patterns. For example, the policies may tighten restrictions during boot-up routines. In some cases, the access control engine 222 checks each inbound access request against the access control policies 228 to make a determination about whether to enable or deny access requests. For access attempts to protected memory regions, the access control engine 222 may initiate a handshake process to establish a secure communication channel by generating key pairs and providing public keys to the requester.

As further depicted in FIG. 2, the RoT CPU complex 202 includes an environment engine 224 that is configured to determine an operational environment of the SoC associated with the ROT CPU complex 202 and enforce one or more restrictions and/or privileges based on the determined operational environment. In some cases, the environment engine 224 may be configured to determine access rates for one or more addresses and use the access rates to determine an operational environment within which the SoC 102 operates. For example, the environment engine 224 may determine (e.g., based on data stored as part of the firmware 232) that devices associated with a particular companies execute code associated with SDKs that frequently access a set of reserved configuration registers. Based on this determination, the environment engine 224 may determine: (i) that the SoC is operating outside the operational environment associated with the company if the access rates for the set of reserved configuration registers falls below a threshold (e.g., if the set of reserved configuration registers are not accessed within a defined past period), and/or (ii) that the SoC is operating inside the operational environment associated with the company if the access rates for the set of reserved configuration registers exceed or equal a threshold (e.g., if the set of reserved configuration registers are accessed within a defined past period).

In some cases, the environment engine 224 is configured to (e.g., via communicating with the fuse box 204) to disable operation of the SoC, enable one or more functionalities of the SoC, and/or disable one or more functionalities of the SoC based on the operational environment within which the 102 is detected to operate. For example, in some cases, if the SoC is reserved for operation within a set of authorized environments, the environment engine 224 may disable the operation of the SoC if the environment engine 224 detects that the SoC is operating outside the authorized set of environments. As another example, in some cases, if a set of functionalities of the SoC are reserved for a set of authorized environments, the environment engine 224 may disable the set of functionalities if the environment engine 224 detects that the SoC is operating outside the authorized set of environments. As another example, in some cases, if a set of functionalities of the SoC are reserved for a set of authorized environments, the environment engine 224 may ensure that the set of functionalities are enabled if the environment engine 224 detects that the SoC is operating inside the authorized set of environments. In some embodiments, by communicating with the fuse box 204, an eFuse may be triggered by the environment engine 224 for the one-time disablement of functions.

In some cases, to determine an operational environment associated with the SoC and/or to enforce restrictions and/or privileges based on the determined operational environment, the environment engine 224 uses the environment policies 230 stored on the firmware 232. The environment policies 230 may define predefined thresholds for access frequencies to sets of addresses that are indicative of certain operational environments. The environment policies 230 may specify that if access requests to a given set of addresses exceed a certain threshold over a defined time period, then the SoC is likely operating in a particular environment associated with frequent access to those addresses. In some cases, if access requests fall below a threshold, the SoC is determined to be operating outside of that environment. The environment policies 230 stored on the firmware 232 may define different access rate thresholds for read requests versus write requests to designated memory addresses. For example, a high volume of writes to certain configuration registers may indicate a development environment, while mainly read access may indicate a production environment. In some cases, the firmware 232 can specify more complex behavioral profiles involving patterns of address access rates that map to different contexts. The environment policies 230 stored on the firmware 232 may also indicate how to interpret relative changes in access patterns over time.

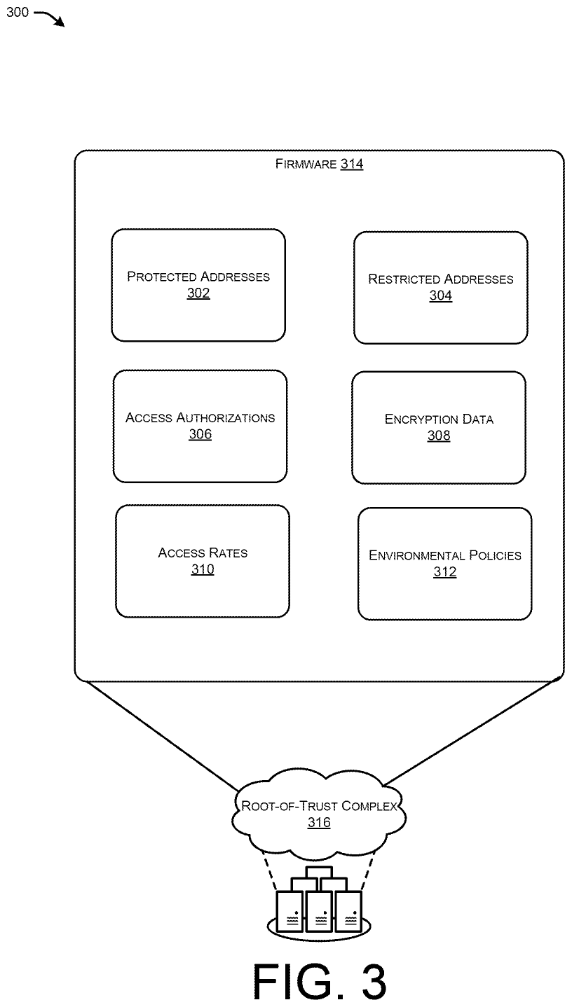

FIG. 3 provides an operational example 300 of firmware 314 that may be accessed by an RoT CPU complex 316. The firmware data may, for example, be stored as part of the firmware stored on an SPI flash memory. As depicted in FIG. 3, the ROT CPU complex 316 accesses the firmware 314, which may include a set of protected addresses 302, a set of restricted addresses 304, a set of access authorizations 306, a set of encryption data 308, a set of access rates 310, and a set of environment policies 312.

The set of protected addresses 302 may designate a set of memory addresses associated with the corresponding SoC that are designated as being protected. In some cases, when a memory address is designated as being protected, the RoT CPU complex 316 only allows access to that address through an authenticated secure channel.

The set of restricted addresses 304 may designate a set of memory addresses that can only be accessed by authorized components of the SoC or externally approved devices. In some cases, when a memory address is designated as being restricted, the RoT CPU complex 316 only allows access to that address to authorized devices and/or components.

The set of access authorizations 306 may designate which devices and/or components are authorized to access a restricted memory address. In some cases, when a memory address is designated as being protected, the RoT CPU complex 316 only allows access to that address to components and/or external devices that are allowed to access as indicated by the set of access authorizations 306. In some cases, when a memory address is designated as being restricted, the ROT CPU complex 316 queries the set of access authorizations 306 to determine whether a device and/or component requesting access to that restricted address is authorized to access the restricted address. In some cases, the set of access authorizations 306 describes, for each restricted address, what type(s) of access to that address is authorized with respect to a particular device and/or component. For example, the set of access authorizations 306 may represent that a first restricted address can be accessed by a first device in a read-only manner, while the first restricted address can be accessed by a second device in a read/write manner.

The set of encryption data 308 may designate keys, certificates, and algorithms used by the RoT CPU complex 316 to implement cryptographic protections for secure channels. For example, the set of encryption data 308 may include the combination of a private key and a public key, or a single private key. In some cases, the RoT CPU complex 316 uses the set of encryption data 308 to determine whether an access request and/or data packet is received using an authorized secure communication channel.

The set of access rates 310 may designate a rate of access to a particular memory address in a defined past period. In some cases, the ROT CPU complex 316 uses the set of access rates to determine the operational environment of the SoC. For example, the ROT CPU complex 316 may determine that devices associated with a particular company execute code associated with SDKs that frequently access a set of reserved configuration registers. Based on this determination, the RoT CPU complex 316 may determine: (i) that the SoC is operating outside the operational environment associated with the company if the access rates for the set of reserved configuration registers falls below a threshold (e.g., if the set of reserved configuration registers are not accessed within a defined past period), and/or (ii) that the SoC is operating inside the operational environment associated with the company if the access rates for the set of reserved configuration registers exceed or equal a threshold (e.g., if the set of reserved configuration registers are accessed within a defined past period).

The set of environment policies 312 may designate access rate thresholds and/or patterns associated with different operational environments, and/or access restrictions and/or privileges associated with different operational environments. The RoT CPU complex 316 adjusts security posture based on the active environment policy. The set of environment policies 312 may define predefined thresholds for access frequencies to sets of addresses that are indicative of certain operational environments. The set of environment policies 312 may specify that if access requests to a given set of addresses exceed a certain threshold over a defined period, then the SoC is likely operating in a particular environment associated with frequent access to those addresses.

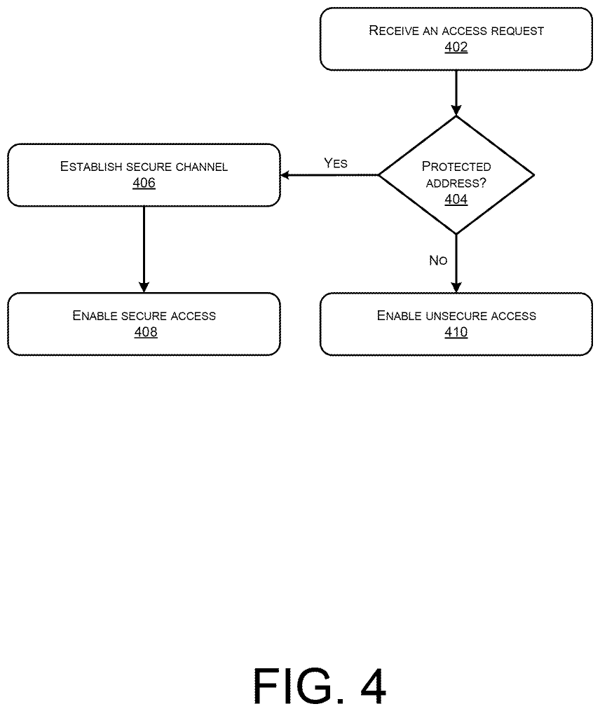

FIG. 4 is a flowchart diagram of an example process 400 for managing access to an SoC address based on whether the address is protected. As depicted in FIG. 4, at operation 402, an example system (e.g., an RoT CPU complex) receives a request to access a memory address associated with the SoC. The request may be received from an external device, such as an external host processor.

At operation 404, the system determines whether the received access request seeks access to a protected address. A protected address may be an address that is accessible only via a secure communication channel. If the system determines that the requested address is protected (operation 404—Yes), the system proceeds to operation 406 to establish a communication channel and then to operation 408 to enable secure access to the requested address using the established channel.

In some cases, to establish a secure communication channel with an external device that has requested access to a protected address, the system generates an asymmetric key pair, provides the public key to the external device, and retains the private key. The system may then use the private key to authenticate requests received via the secure channel and encrypt responses to the external device. The external device may use the public key to encrypt its requests to the protected address. This allows secure communication between the system and external devices needing access to protected memory regions.

If the system determines that the requested address is not protected (operation 404-No), the system proceeds to operation 410 to enable unsecure access without a secure communication channel. The system may still enforce other access controls on the requested address, for example conditionally granting access if the memory address is restricted. In some cases, by selectively establishing secure channels only when accessing protected addresses, the system provides efficient security that reduces computational overhead for non-sensitive memory access while still ensuring critical regions stay protected.

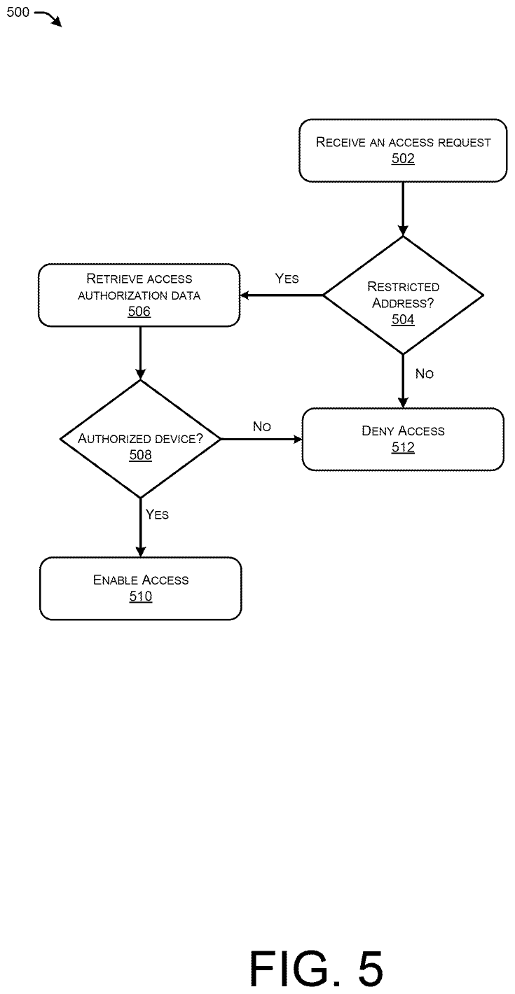

FIG. 5 is a flowchart diagram of an example process 500 for managing access to an SoC address based on whether the address is restricted. As depicted in FIG. 5, at operation 502, an example system (e.g., an RoT CPU complex) receives a request to access a memory address associated with the SoC. The request may be received from an external device, such as an external host processor.

At operation 504, the system determines whether the received access request seeks access to a restricted address. A restricted address may be an address that is accessible only by authorized devices. If the system determines that the requested address is restricted (operation 504—Yes), the system proceeds to operation 506 to retrieve the access authorization for the address and then proceeds to operation 508 described below. The access authorizations may indicate which devices are authorized to access the memory address. In some cases, the access authorizations may be specific to the mode of access requested by the access request (e.g., to read-only accesses and/or to read/write accesses). If the system determines that the requested address is not restricted (operation 504—No), the system proceeds to operation 512 to deny the requested access.

At operation 508, the system determines, based on the access authorizations, whether the requesting device is authorized to access the requested address. For example, the system may determine whether the requesting device is authorized to access the requested address based on the requested access mode. If the system determines that the requesting device is authorized to access the requested address (operation 508—Yes), the system proceeds to operation 510 to enable the requested access. If the system determines that the requesting device is not authorized to access the requested address (operation 512—Yes), the system proceeds to operation 512 to deny the requested access.

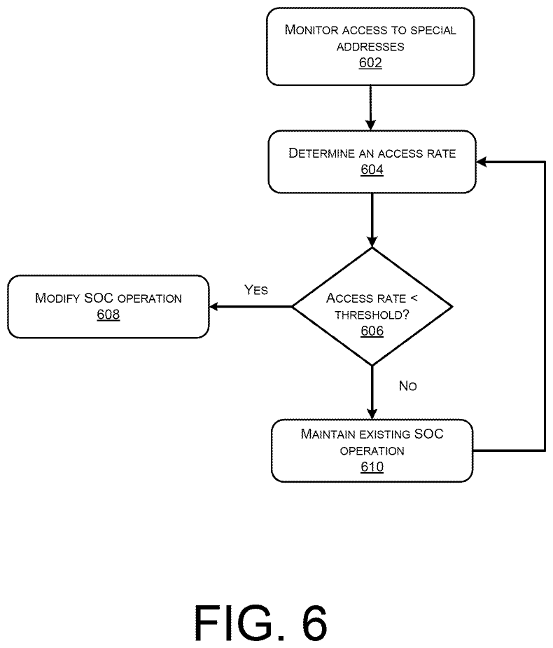

FIG. 6 is a flowchart diagram of an example process 600 for setting an operational configuration of an SoC based on access rates associated with specially-designated addresses associated with the SoC. As depicted in FIG. 6, at operation 602, an example system (e.g., an RoT CPU complex) monitors access requests associated with the specially-designated addresses. In some cases, the system may be configured to intercept all access requests received from external devices (e.g., a host processor) through one or more access interfaces (e.g., through a PCIe interface). For example, a mailbox may be configured to provide all access requests to the system. As another example, a mailbox may be configured to generate an interrupt (e.g., a hardware interrupt) signal when the mailbox receives an access request from an external device through an access interface. As another example, the system may be configured to execute operations that are configured to monitor access requests received by a mailbox.

At operation 604, the system determines one or more access rates associated with the specially-designated addresses. For example, the system may compute the frequency of a set of requests (e.g., a set of read requests, a set of write requests, a set of read and write requests, and/or the like). In some cases, an access rate is determined for all of the specially-designated addresses. In some cases, an access rate is determined for each of the specially-designated addresses.

At operation 606, the system determines whether the one or more access rates exceed a threshold. If the system determines that the access rates exceed a threshold (operation 606—Yes), the system proceeds to operation 608 to modify an operation of the SoC. Modifying the operation of the SoC may include disabling the operation of the SoC, enabling one or more functionalities associated with the SoC, and/or disabling one or more functionalities associated with the SoC. If the system determines that the access rates fail to exceed the threshold (operation 606—No), the system proceeds to operation 610 to maintain the existing operational state associated with the SoC. In some cases, the system determines an operational environment of the SoC based on correlating the observed access rates to expected rate profiles associated with different environments. For example, frequent writes to certain registers may indicate a test environment while mainly read access could imply a production setting. In some cases, the system configures security aspects of the SoC according to restrictions and permissions associated with the determined operational environment.

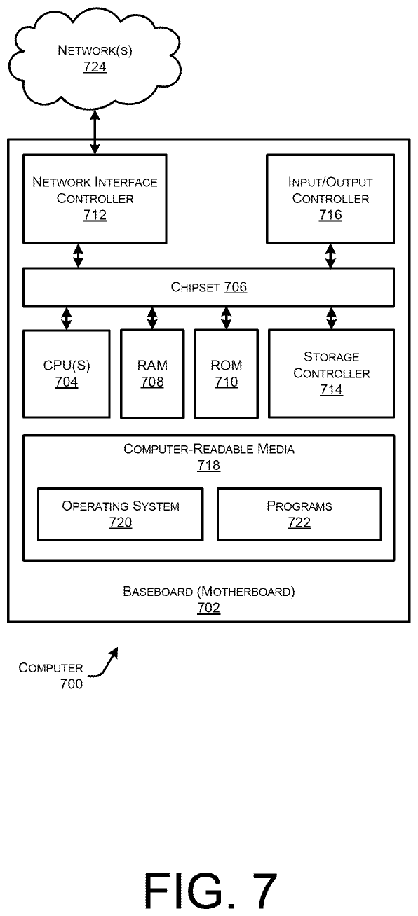

FIG. 7 shows an example computer architecture for a computer 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The computer 700 may, in some examples, correspond to a physical server that is included in the SoC 102 described herein, and may comprise networked devices such as servers, switches, routers, hubs, bridges, gateways, modems, repeaters, access points, etc.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 724. The chipset 706 can include functionality for providing network connectivity through a NIC 712, such as a gigabit Ethernet adapter. The NIC 712 is capable of connecting the computer 700 to other computing devices over the network 724. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations are performed by devices in a distributed application architecture, and or any components included therein, may be supported by one or more devices similar to computer 700. Stated otherwise, some or all of the operations performed by the SoC 102, and or any components included therein, may be performed by one or more computers 700 operating in any system or arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-7. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of operating a system-on-chip (SoC), comprising:
intercepting, by an isolated Root of Trust (ROT) code and from an interconnect component associated with the SoC, a first access request by a first device, wherein the first access request is associated with a first memory address of the SoC;
determining, by the isolated ROT code, that the first memory address is protected;
based on determining that the first memory address is protected, establishing, by the isolated ROT code, a secure communication channel between the first device and the isolated ROT code; and
providing, by the isolated ROT code and using the secure communication channel, first data determined based on contents of the first memory address to the first device.

2. The method of claim 1, further comprising:
intercepting, by the isolated ROT code and from the interconnect component, a second access request by a second device, wherein the second access request is associated with a second memory address of the SoC;
determining, by the isolated ROT code, that the second memory address is restricted;
based on determining that the second memory address is restricted, determining, by the isolated ROT code, that the second device is unauthorized to access the second memory address; and
based on determining that the second device is unauthorized to access the second memory address, aborting, by the isolated ROT code, processing of the second access request.

3. The method of claim 1, wherein intercepting the first access request comprises:
monitoring data received by the interconnect component.

4. The method of claim 1, wherein intercepting the first access request comprises:
at a time prior to intercepting the first access request, generating configuration data associated with the interconnect component that defines the first memory address in a memory address space associated with the isolated ROT code.

5. The method of claim 1, wherein intercepting the first access request comprises:
receiving a hardware interrupt from a hardware component associated with the interconnect component, wherein the hardware component may be configured to generate hardware interrupts based on detecting requests to access a set of protected memory addresses, and wherein the set of protected memory addresses comprise the first memory address.

6. The method of claim 1, wherein intercepting the first access request comprises:
executing operations associated with the interconnect component using the isolated ROT code.

7. The method of claim 1, wherein the interconnect component is associated with a Peripheral Component Interconnect Express (PCIe) protocol.

8. The method of claim 1, further comprising:
receiving, by the isolated ROT code and using the secure channel, a second access request; and
validating, by the isolated ROT code and using a cryptographic accelerator hardware, the second access request.

9. The method of claim 8, wherein the second access request is associated with a request for modification of the contents associated with the first memory address based on second data, and the method further comprises:
based on validating the second access request, modifying, by the isolated ROT code, the contents based on the second data.

10. A method of operating a system-on-chip (SoC), comprising:
determining, by an isolated Root of Trust (ROT) code, that an access rate associated with a first memory address associated with the SoC falls below a threshold, wherein the first memory address is associated with an expected operational environment of the SoC;
based on determining that the access rate falls below the threshold, determining that the SoC is operating outside the expected operational environment; and
based on determining that the SoC is operating outside the expected operational environment, modifying, by the isolated ROT code, operation of the SoC, wherein modifying the operation of the SoC comprises at least one of:
disabling operation of the SoC,
disabling a first functionality associated with the SoC, or
enabling a first functionality associated with the SoC.

11. The method of claim 10, wherein the access rate is determined based on a number of requests to access a set of memory addresses accessed by a software application that is deployed within the expected operational environment.

12. The method of claim 10, wherein modifying operation of the SoC comprises requiring data determined based on contents of a memory address of the SoC to be encrypted prior to providing the data to a requesting device.

13. A system of operating a system-on-chip (SoC), the system comprising:
one or more processors; and
one or more non-transitory computer-readable media storing computer-executable instructions that, when executed by the one or more processors, cause the one or more processors to perform operations comprising:
intercepting, by an isolated Root of Trust (ROT) code and from an interconnect component associated with the SoC, a first access request by a first device, wherein the first access request is associated with a first memory address of the SoC;
determining, by the isolated ROT code, that the first memory address is protected;
based on determining that the first memory address is protected, establishing, by the isolated ROT code, a secure communication channel between the first device and the isolated ROT code; and
providing, by the isolated ROT code and using the secure communication channel, first data determined based on contents of the first memory address to the first device.

14. The system of claim 13, the operations further comprising:
intercepting, by the isolated ROT code and from the interconnect component, a second access request by a second device, wherein the second access request is associated with a second memory address of the SoC;
determining, by the isolated ROT code, that the second memory address is restricted;
based on determining that the second memory address is restricted, determining, by the isolated ROT code, that the second device is unauthorized to access the second memory address; and
based on determining that the second device is unauthorized to access the second memory address, aborting, by the isolated ROT code, processing of the second access request.

15. The system of claim 13, wherein intercepting the first access request comprises:
monitoring data received by the interconnect component.

16. The system of claim 13, wherein intercepting the first access request comprises:
at a time prior to intercepting the first access request, generating configuration data associated with the interconnect component that defines the first memory address in a memory address space associated with the isolated ROT code.

17. The system of claim 13, wherein intercepting the first access request comprises:
receiving a hardware interrupt from a hardware component associated with the interconnect component, wherein the hardware component may be configured to generate hardware interrupts based on detecting requests to access a set of protected memory addresses, and wherein the set of protected memory addresses comprise the first memory address.

18. The system of claim 13, wherein intercepting the first access request comprises:
executing operations associated with the interconnect component using the isolated ROT code.

19. The system of claim 13, wherein the interconnect component is associated with a Peripheral Component Interconnect Express (PCIe) protocol.

20. The system of claim 13, the operations further comprising:
receiving, by the isolated ROT code and using the secure channel, a second access request; and
validating, by the isolated ROT code and using a cryptographic accelerator hardware, the second access request.
